(19) United States
(12) Patent Application Publication
(10) Pub. No.: US 2008/0260360 A1
(43) Pub. Date: Oct. 23, 2008

(54) Video recording apparatus

(75) Inventor: Yoshikazu Fujishima, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/081,349

(22) Filed: Apr. 15, 2008

(30) Foreign Application Priority Data
Apr. 18, 2007 (JP) 2007-108812

(51) Int. Cl. H04N 5/00

(52) U.S. Cl. 386/126; 386/E05.064

(57) ABSTRACT

A main microcomputer of the DVD recorder includes a first transmission portion for transmitting set information of a VCR recording part to a sub microcomputer if the VCR recording part is connected. The sub microcomputer includes a judgment portion for checking whether or not the set information of the VCR recording part has been received from the first transmission portion and a second transmission portion for transmitting the set information of the VCR recording part to a VCR microcomputer disposed in the VCR recording part when the judgment portion judges that the set information of the VCR recording part has been received.

This application is based on Japanese Patent Application No. 2007-108812 filed on Apr. 18, 2007, and the contents of which are hereby incorporated by reference.

### BACKGROUND OF THE INVENTION

1. Field of the Invention

The present invention relates to a video recording apparatus that can receive a television broadcast and has a connectable first recording part including a first recording medium for storing received video information. In particular, the present invention relates to a DVD recorder that can receive a television broadcast and has a hard disk drive (HDD) recording part, a digital versatile disc (DVD) recording part and a connectable video cassette recorder (VCR) recording part, for storing received video information.

2. Description of Related Art

There are widespread video recording apparatuses such as a DVD recorder that is used for receiving a television broadcast so as to record video information of the received television broadcast on a recording medium and for reproducing the recorded video information with a television device connected to the DVD recorder, if required. In addition, it is known that there is a video recording apparatus such as a DVD recorder that has a main control part (e.g., a main microcomputer) for controlling a general operation of the video recording apparatus and a sub control part (e.g., a sub microcomputer) for controlling power supply of the video recording apparatus.

For example, JP-A-2007-41850 discloses a DVD recorder having a main microcomputer that sends to a sub microcomputer power supply control data indicating an approach for controlling power supply by communication and the sub microcomputer that controls the power supply according to the approach indicated in the power supply control data received from the main microcomputer. This DVD recorder can change the approach for controlling the power supply by the sub microcomputer.

However, concerning the conventional video recording apparatus such as the DVD recorder described above, the sub microcomputer in the case where a recording part such as a VCR controlled by the sub microcomputer is connected (or incorporated) is required different functions from the case where the recording part is not connected (or incorporated). Therefore, it is necessary to use different sub microcomputers in accordance with whether or not the recording part such as the VCR is connected (or incorporated). For example, it is difficult to use the same sub microcomputer in a DVD recorder equipped with an HDD and in a DVD recorder equipped with not only an HDD but also a VCR recording part. Therefore, it is necessary to prepare many types of sub microcomputers, which may cause an increase of manufacturing cost.

### SUMMARY OF THE INVENTION

It is an object of the present invention to provide a video recording apparatus that can use the same sub control part regardless of whether or not a recording part is connected.

In order to achieve the above-mentioned object, a video recording apparatus is provided: a main control part for controlling a operation of the entire video recording apparatus receiving a television broadcast wave and being capable of connecting to a first recording part having a first recording medium for storing received video information, the main control part including a first transmission portion for transmitting set information of the first recording part if the first recording part is connected to the video recording apparatus; and a sub control part for controlling a power supply of the video recording apparatus and for controlling communication with a medium control part disposed in the first recording part so as to control read and write on the first recording medium, the sub control part including a judgment portion for checking whether or not the set information of the first recording part transmitted from the first transmission portion has been received, and a second transmission portion for transmitting the set information of the first recording part to the medium control part if the judgment portion judges that the set information of the first recording part has been received.

In other words, if the first recording part is connected, the main control part transmits the set information of the first recording part to the sub control part. In addition, if it is judged in the sub control part that the set information of the first recording part has been received, the set information of the first recording part is transmitted to the medium control part. Therefore, if the first recording part is connected, the set information of the first recording part is setting of the first recording part transmitted to the medium control part, and setting of the first recording part is performed. On the contrary, if the first recording part is not connected to the sub control part, the set information of the first recording part is not transmitted to the medium control part, so that the setting of the first recording part is not performed. Therefore, the same sub control part can be used regardless of whether or not the recording part (here, the first recording part) is connected.

In other words, if the first recording part is connected, setting of the first recording part is performed based on the set information of the first recording part received from the main control part via the sub control part in the medium control part that is a control part for controlling read and write on the first recording medium. Therefore, the setting is performed so that the first recording part can be used.

In order to achieve the above-mentioned object, a video recording apparatus of the present invention may be adapted to have a generating portion for generating a communication controlling portion for controlling communication with the medium control part based on the received set information if the judgment portion judges that the set information of the first recording part has been received in the sub control part. Therefore, the same sub control part can be used regardless of whether or not the recording part (here, the first recording part) is connected.

In other words, if it is judged that the set information of the first recording part has been received in the sub control part, the communication controlling portion is generated for controlling communication with the medium control part that is a control part for controlling read and write on the first recording medium based on the received set information. Therefore, communication between the sub control part and the first recording part can be controlled. Therefore, the same sub control part can be used regardless of whether or not the recording part (here, the first recording part) is connected.

In addition, if it is judged that the set information of the first recording part has been received, the communication controlling portion is generated for controlling communication with the medium control part that is a control part for controlling read and write on the first recording medium. If it is judged that the set information of the first recording part has not been received, the communication controlling portion is not generated for controlling communication with the medium control part that is a control part for controlling read and write on the first recording medium. Therefore, the sub control part is not required to have a needless (i.e., useless) function (here, the function for controlling communication with the medium control part) if the recording part (here, the first recording part) is not disposed.

In order to achieve the above-mentioned object, a video recording apparatus of the present invention may be adapted to have the first transmission portion transmits the set information of the first recording part when the power supply is switched on for the first time. Therefore, the recording part (here, the first recording part) can be used with a good convenience in the case where the recording part (here, the first recording part) is disposed.

In other words, since the set information of the first recording part is transmitted when the power supply is switched on for the first time, the first recording part can be used at the first switch-on of the power supply after the video recording apparatus is purchased (or after it has been produced). Therefore, the user can use the first recording part soon after purchasing.

In order to achieve the above-mentioned object, a video recording apparatus of the present invention may be adapted to have the main control part controls operation of a second recording part having a second recording medium for storing the received video information and operation of a third recording part having a third recording medium for storing the received video information. Therefore, the video recording apparatus of the present invention can store the received video information in the second recording medium and the third recording medium adding to the first recording medium.

In order to achieve the above-mentioned object, as to the video recording apparatus of the present invention, the first recording part may be a VCR recording part having a VCR (Video Cassette Recorder) as the first recording medium, the second recording part may be an HDD (Hard Disk Drive) having a hard disk as the second recording medium, and the third recording part may be a DVD (Digital Versatile Disc) recording part having a DVD as the third recording medium. Therefore, the video recording apparatus according to the present invention can store the received video information in the VCR, the hard disk and the DVD.

In order to achieve the above-mentioned object, as to the video recording apparatus of the present invention, each of the main control part, the sub control part and the medium control part may be made of a microcomputer. Therefore, the apparatus can be realized by a simple configuration.

### BRIEF DESCRIPTION OF THE DRAWINGS

FIG. 1 is a block diagram showing an example of configuration of a DVD recorder according to the present invention.

FIG. 2 is a functional configuration diagram showing an example of configuration of a main part of the DVD recorder according to the present invention.

FIG. 3 is a flowchart showing an example of operation of the DVD recorder (mainly, a sub microcomputer) according to the present invention.

FIG. 4 is a block diagram showing a state of communication among a main microcomputer, the sub microcomputer and a VCR microcomputer in the case where a VCR recording part is incorporated.

### DETAILED DESCRIPTION OF THE PREFERRED EMBODIMENTS

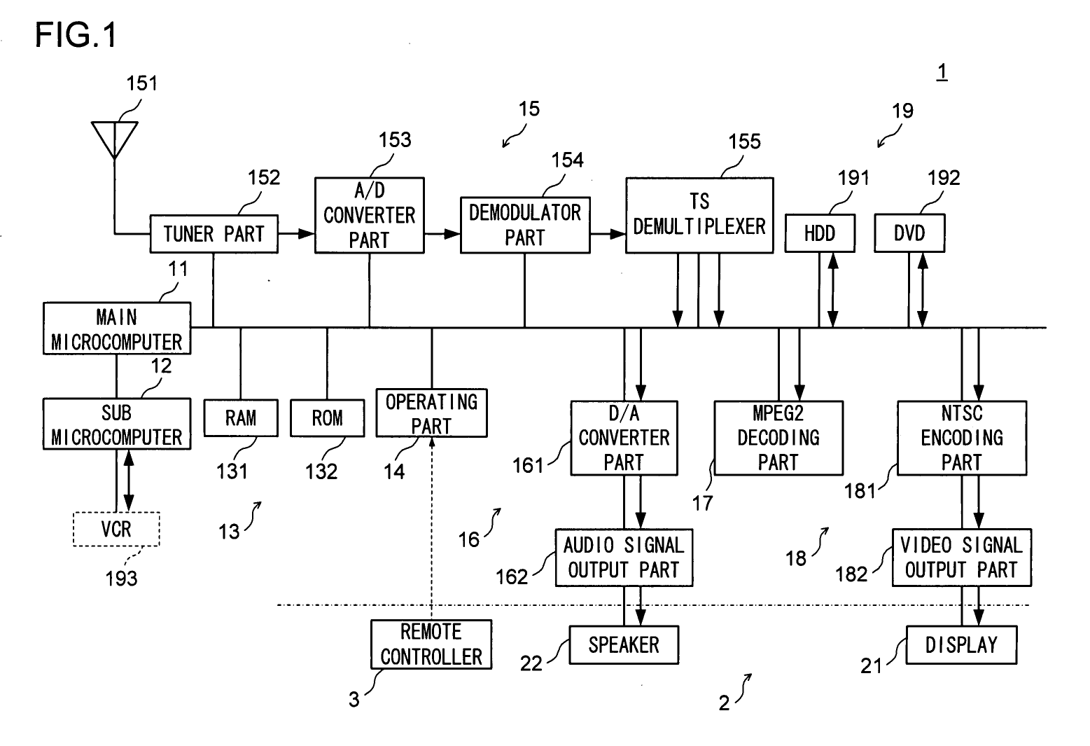

Hereinafter, embodiments of the present invention will be described with reference to the attached drawings. FIG. 1 is a block diagram showing an example of configuration of a DVD recorder according to the present invention. A DVD recorder 1 (a DVD recorder having an HDD, which corresponds to the video recording apparatus) is connected to an output device 2 so that they can communicate with each other. It is also connected to a remote controller 3 so that they can communicate with each other by infrared communication. In addition, the DVD recorder 1 is adapted to be capable of incorporating a VCR recording part 193.

The DVD recorder 1 receives operated input from the remote controller 3 operated by a user. Then, it receives a television broadcast and stores received program information in a hard disk of a HDD 191, a DVD of a DVD recording part 192 or the like based on the received operated input. In addition, the DVD recorder 1 reads the program information stored in the hard disk of the HDD 191, the DVD of the DVD recording part 192 or the like to output pictures and sounds of the program information to the output device 2.

The output device 2 has a display 21 and a speaker 22 for output sound information and video information supplied from the DVD recorder 1. The display 21 includes a liquid crystal display (LCD), a plasma display panel (PDP) or the like for displaying video information supplied from the DVD recorder 1, so that it can be viewed externally. The speaker 22 outputs audio information supplied from the DVD recorder 1.

The remote controller 3 recognizes operated input by the user and generates an infrared signal corresponding to the operated input recognized in the remote controller 3, which is transmitted to the DVD recorder 1.

In addition, the DVD recorder 1 includes a main microcomputer 11, a sub microcomputer 12, a RAM 131, a ROM 132, an operating part 14, a receiving part 15, a audio output part 16, an MPEG2 decoding part 17, an image output part 18 and a recording part 19. Furthermore, the recording part 19 includes the HDD 191 and the DVD recording part 192, and being adapted to be capable of incorporating a VCR recording part 193.

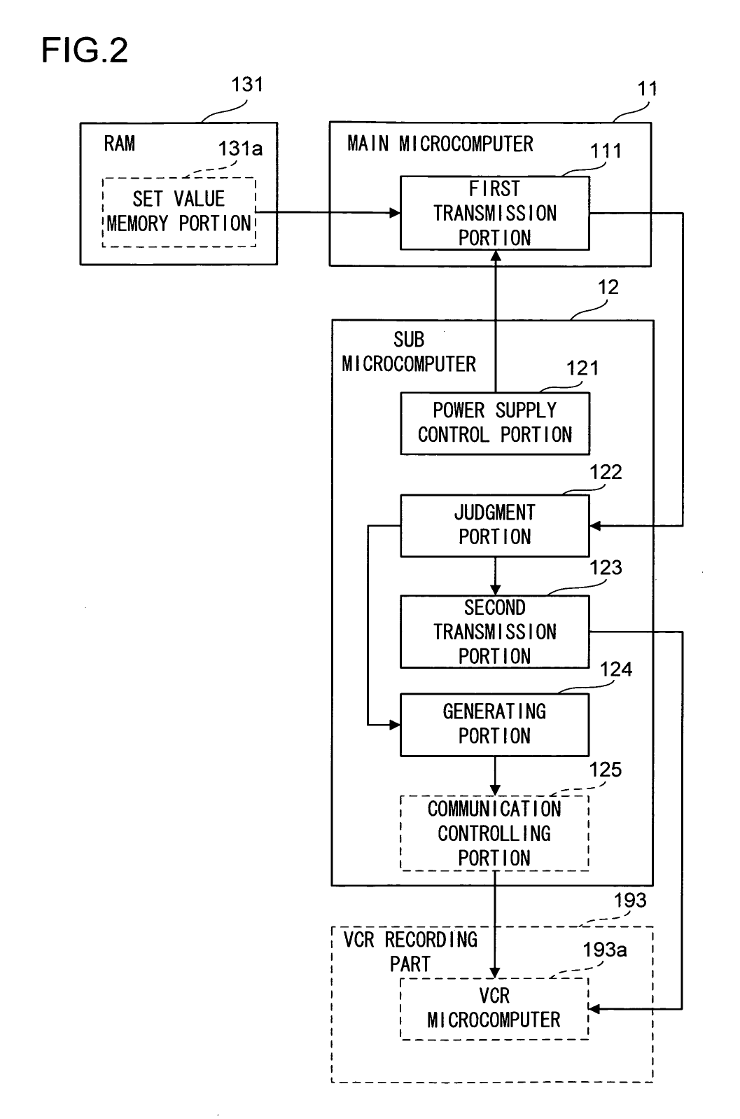

The main microcomputer 11 (corresponding to the main control part) controls operation of the entire DVD recorder 1. The sub microcomputer 12 (corresponding to the sub control part) controls a power supply in the DVD recorder 1 and controls communication with a VCR microcomputer 193a (see FIG. 2) that is disposed in the VCR recording part 193 for controlling read and write operations of the VCR recording part 193. The RAM (Random Access Memory) 131 stores information such as the audio information, the video information and the like in a readable and rewritable manner. The ROM (Read Only Memory) 132 stores a control program and the like for the main microcomputer 11 to execute.

The operating part 14 receives a various types of operated inputs for turning on and off the power supply, selecting a TV program and the like. In addition, the operating part 14 receives various types of operated inputs from the remote controller 3 via the infrared communication. The receiving part 15 includes an antenna part 151, a tuner part 152, an A/D converter part 153, a demodulator part 154, and a TS (Transport Stream) demultiplexer 155. Then the receiving part 15 receives and demodulates the broadcasting waves.

The antenna part 151 receives television broadcasting waves. The tuner part 152 selects a preset channel of broadcasting among the television broadcasting waves received by the antenna part 151. The A/D converter part 153 converts an output signal (i.e., and analog signal) of the tuner part 152 into digital information. The demodulator part 154 demodulates output information from the A/D converter part 153. The TS (Transport Stream) demultiplexer 155 demultiplexes and assorts the demodulated output information from the demodulator part 154, which are outputted.

The audio output part 16 includes a D/A converter part 161 and an audio signal output part 162, and outputs to the speaker 22 an audio signal corresponding to the broadcasting waves received by the receiving part 15. The D/A converter part 161 converts the audio information (i.e., the digital information) supplied from the TS demultiplexer 155 into an analog signal. The audio signal output part 162 outputs to the speaker 22 the audio signal as an analog signal converted by the D/A converter part 161.

The MPEG2 (Motion Picture Experts Group 2) decoding part 17 decodes the video information supplied from the TS demultiplexer 155 into video information before its compression.

The image output part 18 includes an NTSC (National Television Standards Committee) encoding part 181 and a video signal output part 182, and outputs a video signal decoded by the MPEG2 decoding part 17 to the display 21. The NTSC encoding part 181 converts the video information decoded by the MPEG2 decoding part 17 into a television signal of NTSC format. The video signal output part 182 outputs the television signal of NTSC format supplied from the NTSC encoding part 181 to the display 21.

The HDD 191 (corresponding to the second recording part) has a hard disk (corresponding to the second recording medium), and stores various pieces of information such as the video information and the audio information in the hard disk in accordance with an instruction from the main microcomputer 11 and reading the various pieces of information such as the video information and the audio information stored in the hard disk. The DVD recording part 192 (corresponding to the third recording part) is adapting to be capable of loading a DVD (corresponding to the third recording medium). In addition, the DVD recording part 192 records (i.e., writes) various pieces of information such as the video information and the audio information on a loaded DVD in accordance with an instruction from the main microcomputer 11, and it also reads out the various pieces of information such as the video information and the audio information stored in the DVD.

The VCR recording part 193 (corresponding to the first recording part) includes the VCR microcomputer 193a (see FIG. 2) and is adapting to be capable of loading a VC (Video Cassette, which corresponds to the first recording medium). In addition, the VCR recording part 193 records (i.e., writes) various pieces of information such as the video information and the audio information on a loaded VC in accordance with an instruction from the sub microcomputer 12, and it reads out the various pieces of information such as the video information and the audio information stored in the VC. Furthermore, the VCR recording part 193 is adapted to be connectable to the sub microcomputer 12. The VCR microcomputer 193a (corresponding to the medium control part) controls operation of the entire VCR recording part 193.

Next, an operation of the DVD recorder 1 when it receives broadcast waves will be described. First, transmitted digital airwaves are received by the antenna part 151. If a selection operation is accepted via the operating part 14, the tuner part 152 switches a transponder for receiving. The received digital airwave is converted by the A/D converter part 153 into digital information, which is demodulated by the demodulator part 154.

Note that the digital airwave is transmitted as a TS (Transport Stream) packet from a transmission side (a transmission station). This TS packet includes the video information, the audio information, control information and the like, which are demultiplexed, assorted and output by the TS demultiplexer 155 to be stored in the RAM 131. Then, the audio information read out from the RAM 131 is converted by the D/A converter part 161 into an analog signal, so that sounds are produced from the speaker 22 via the audio signal output part 162.

In addition, the video information read out from the RAM 131 is decoded by the MPEG2 decoding part 17 to be video information before its compression, which is converted by the NTSC encoding part 181 into a television signal of NTSC format. Then, pictures are displayed on the display 21 via the video signal output part 182.

FIG. 2 is a functional configuration diagram showing an example of configuration of a main part of the DVD recorder 1 according to the present invention. The main microcomputer 11 includes a first transmission portion 111, as its functions. The RAM 131 includes a set value memory portion 131a, as its functions. In addition, the sub microcomputer 12 includes a power supply control portion 121, a judgment portion 122, a second transmission portion 123 and a generating portion 124, as its functions.

Here, the main microcomputer 11 reads out the control program previously stored in the ROM 132 or the like shown in FIG. 1 and executes the control program, so as to work as functional portions such as the first transmission portion 111. In addition, the main microcomputer 11 makes the RAM 131 work as functional portions such as the set value memory portion 131a and makes the sub microcomputer 12 work as functional portions such as the power supply control portion 121, the judgment portion 122, the second transmission portion 123 and the generating portion 124.

In addition, among various data stored in the RAM 131 and the ROM 132 shown in FIG. 1, data that can be stored in a removable recording medium may be readable by drive units such as an HDD, an optical disc drive, a flexible disc drive, a silicon disc drive, a cassette medium reader, for example. In this case, the recording medium corresponds to a hard disk, an optical disc, a flexible disc, a CD (Compact Disc), a DVD, a semiconductor memory or the like, for example.

If the VCR recording part 193 is connected (or incorporated), the set value memory portion 131a previously stores set information of the VCR recording part 193. In addition, the set information of the VCR recording part 193 stored in the set value memory portion 131a is read out by the first transmission portion 111.

The first transmission portion 111 checks whether or not the VCR recording part 193 is connected when it receives information indicating first switch-on of the power supply from the power supply control portion 121. If it judges that the VCR recording part 193 is connected, the set information of the VCR recording part 193 stored in the set value memory portion 131a is read out, so that the set information of the VCR recording part 193 is transmitted to the sub microcomputer 12. In this embodiment, the first transmission portion 111 checks whether or not the VCR recording part 193 is connected based on whether or not the set information of the VCR recording part 193 is stored in the set value memory portion 131a, for example.

The power supply control portion 121 controls power supply of the entire DVD recorder 1. The power supply control portion 121 checks whether or not the switch-on of the power supply is a first time. If it is judged that the switch-on of the power supply is a first time, the information indicating first switch-on of the power supply is transmitted to the first transmission portion 111.

The judgment portion 122 checks whether or not the set information of the VCR recording part 193 has been received from the first transmission portion 111.

When the judgment portion 122 judges that the set information of the VCR recording part 193 has been received, the second transmission portion 123 transmits the set information of the VCR recording part 193 to the VCR microcomputer 193a disposed in the VCR recording part 193.

When the judgment portion 122 judged that the set information of the VCR recording part 193 has been received, the generating portion 124 generates the communication controlling portion 125 for controlling communication with the VCR microcomputer 193a disposed in the VCR recording part 193 based on the received set information.

The communication controlling portion 125 controls the communication with the VCR microcomputer 193a disposed in the VCR recording part 193. However, since the communication controlling portion 125 is generated by the generating portion 124 when the judgment portion 122 judges that the set information of the VCR recording part 193 has been received, it is not generated when the judgment portion 122 judges that the set information of the VCR recording part 193 has not been received.

The VCR microcomputer 193a receives the set information of the VCR recording part 193 from the second transmission portion 123 and performs initial setting of the entire VCR recording part 193 based on the received set information.

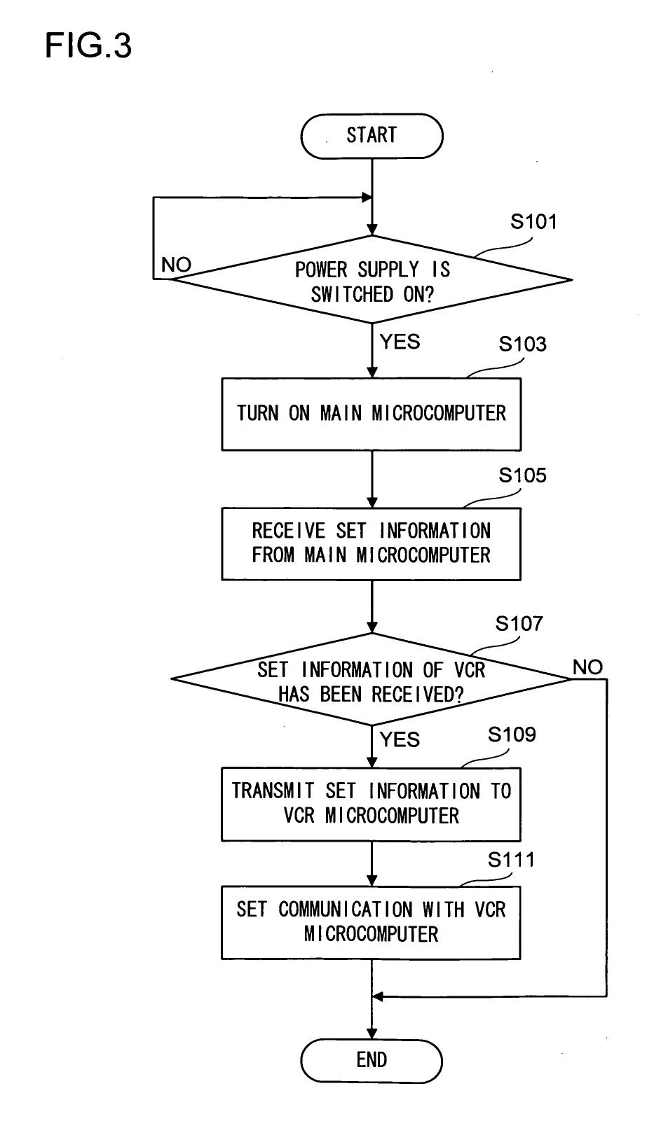

FIG. 3 is a flow chart showing an example of an operation of the DVD recorder 1 (mainly, the sub microcomputer 12) according to the present invention. First, the power supply control portion 121 checks whether or not the switch-on of the power supply is a first time (S101). If it is judged that the switch-on of the power supply is not a first time (NO in S101), processing becomes a stand-by state. If it is judged that the switch-on of the power supply is a first time (YES in S101), the power supply control portion 121 turns on the power supply for the main microcomputer 11 (S103). Then, the judgment portion 122 receives the set information of the VCR recording part 193 from the main microcomputer 11 (the first transmission portion 111) (S105).

Then, the judgment portion 122 checks whether or not the set information of the VCR recording part 193 has been received (S107). If it is judged that the set information of the VCR recording part 193 has not been received (NO in S107), processing is ended. If it is judged that that set information of the VCR recording part 193 is received (YES in S107), the second transmission portion 123 transmits the set information of the VCR recording part 193 to the VCR microcomputer 193a disposed in the VCR recording part 193 (S109). Then, the generating portion 124 generates the communication controlling portion 125 for controlling the communication with the VCR microcomputer 193a (S111), so that processing is ended.

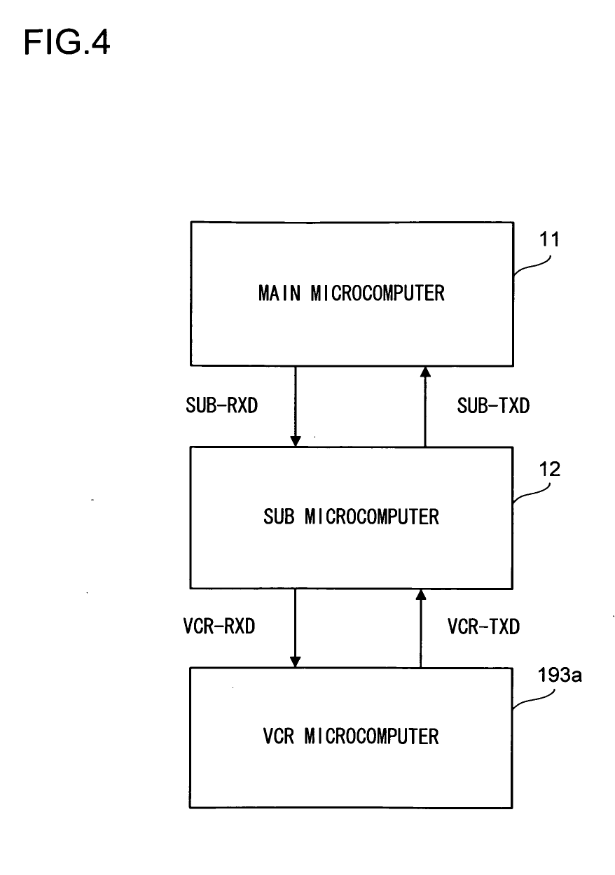

FIG. 4 is a block diagram showing a state of communication among the main microcomputer 11, the sub microcomputer 12 and the VCR microcomputer 193a in the case where the VCR recording part 193 is incorporated. Here, communication of various pieces of information is performed between the main microcomputer 11 and the sub microcomputer 12 by full duplex asynchronous serial communication. Furthermore, the main microcomputer 11 transmits various instruction information (i.e., SUB-RXD) to the sub microcomputer 12, and the sub microcomputer 12 transmits various state information (i.e., SUB-TXD) to the main microcomputer 11. In other words, the main microcomputer 11 controls operation of the sub microcomputer 12 with the instruction information (i.e., SUB-RXD) and the state information (i.e., SUB-TXD).

In addition, communication of various pieces of information is performed between the sub microcomputer 12 and the VCR microcomputer 193a by synchronous serial communication. Furthermore, the sub microcomputer 12 transmits various instruction information (i.e., TCR-RXD) to the VCR microcomputer 193a, and the VCR microcomputer 193a transmits various state information (i.e., TCR-TXD) to the sub microcomputer 12. In other words, the sub microcomputer 12 controls the VCR microcomputer 193a with the instruction information (i.e., TCR-RXD) and the state information (i.e., TCR-TXD).

In this way, the main microcomputer 11 that controls the operation of the entire DVD recorder 1 transmits the set information of the VCR recording part 193 to the sub microcomputer 12 if the VCR recording part 193 is connected. Furthermore, the sub microcomputer 12, which controls the power supply of the DVD recorder 1 and controls communication with the VCR microcomputer 193a that is a control part for controlling read and write on the VC loaded to the VCR recording part 193, checks whether or not the set information of the VCR recording part 193 has been received. If it is judged that the set information of the VCR recording part 193 has been received, the set information of the VCR recording part 193 is transmitted to the VCR microcomputer 193a. Therefore, the same sub microcomputer 12 can be used regardless of whether or not the recording part (here, the VCR recording part 193) is connected.

In other words, in the case where the VCR recording part 193 is connected, if the main microcomputer 11 has transmitted the set information of the VCR recording part 193 to the sub microcomputer 12, and if the sub microcomputer 12 judges that the set information of the VCR recording part 193 has been received, the set information of the VCR recording part 193 is transmitted to the VCR microcomputer 193a. Therefore, if the VCR recording part 193 is connected, the set information of the VCR recording part 193 is transmitted to the VCR microcomputer 193a, so that setting of the VCR recording part 193 is performed. In the contrary, if the VCR recording part 193 is not connected, the set information of the VCR recording part 193 is not transmitted to the VCR microcomputer 193a, so that setting of the VCR recording part 193 is not performed. Therefore, the same sub microcomputer 12 can be used regardless of whether or not the recording part (here, the VCR recording part 193) is connected.

In other words, if the VCR recording part 193 is connected, the VCR microcomputer 193a that is the control part for controlling read and write on the VC performs setting of the VCR recording part 193 based on the set information of the VCR recording part 193 received from the main microcomputer 11 via the sub microcomputer 12. Therefore, the setting is performed, so that the VCR recording part 193 can be used.

In addition, if the sub microcomputer 12 judges that the set information of the VCR recording part 193 has been received, the communication controlling portion 125 is generated for controlling communication with the VCR microcomputer 193a based on the received set information. Therefore, the same sub microcomputer 12 can be used regardless of whether or not the recording part (here, the VCR recording part 193) is connected.

In other words, if the sub microcomputer 12 judges that the set information of the VCR recording part 193 has been received, the communication controlling portion 125 is generated for controlling communication with the VCR microcomputer 193a that is the control part for controlling read and write on the VC based on the received set information. Therefore, communication between the sub microcomputer 12 and the VCR recording part 193 can be controlled, so that the same sub microcomputer 12 can be used regardless of whether or not the recording part (here, the VCR recording part 193) is connected.

In addition, if it is judged that the set information of the VCR recording part 193 has been received, the communication controlling portion 125 is generated for controlling communication with the VCR microcomputer 193a that is the control part for controlling read and write on the VC. If it is judged that the set information of the VCR recording part 193 has not been received, the communication controlling portion 125 is not generated, which controls communication with the VCR microcomputer 193a that is the control part for controlling read and write on the VC. Therefore, the sub microcomputer 12 is not required to incorporate a needless (i.e., useless) function (here, the function for controlling communication with the VCR recording part 193) if the recording part (here, the VCR recording part 193) is not disposed.

In addition, since the set information of the VCR recording part 193 is transmitted when the power supply is switched on for the first time, the recording part (here, the VCR recording part 193) can be used with a good convenience in the case where the recording part (here, the VCR recording part 193) is disposed.

In other words, since the set information of the VCR recording part 193 is transmitted when the power supply is switched on for the first time, the VCR recording part 193 can be used at the first switch-on of the power supply after the DVD recorder 1 is purchased (or after it has been produced). Therefore, the user can use the VCR recording part 193 soon after purchasing.

In addition, the main microcomputer 11 controls operation of the HDD 191 having the hard disk in which the received video information is stored and operation of the DVD recording part 192 having the DVD in which the received video information is stored. Therefore, the received video information can be stored in the hard disk and the DVD adding to the VC.

Note that the present invention can also be applied to the following structure.

(A) Although the video recording apparatus is the DVD recorder 1 in the embodiment described above, it is sufficient if the video recording apparatus is an apparatus that can receive a television broadcast and being adapted to connect to a first recording part having a first recording medium for storing received video information. For example, the video recording apparatus may be a VCR (Video Cassette Recorder) equipped with an HDD.

(B) Although the DVD recorder 1 is adapted to connect the sub microcomputer 12 to the VCR recording part 193 in the embodiment described above, it may be adapted to connect the sub microcomputer 12 to other types of recording parts (e.g., a DVD recording part, an HDD or the like). Furthermore, it may be adapted to connect the sub microcomputer 12 to a plurality of recording parts (e.g., a DVD recording part, an HDD and the like).

(C) Although the DVD recorder 1 has the HDD 191 and the DVD recording part 192 in the embodiment described above, it is sufficient if it has at least one recording part. For example, the DVD recorder 1 may be adapted to have one recording part (e.g., a DVD recording part) or three or more recording parts (e.g., a DVD recording part, an HDD, a VCR recording part and the like).

What is claimed is:

1. A video recording apparatus comprising:
a main control part for controlling operation of the entire video recording apparatus receiving a television broadcast wave and being capable of connecting to a first recording part having a first recording medium for storing received video information, the main control part including
a first transmission portion for transmitting set information of the first recording part if the first recording part is connected to the video recording apparatus; and
a sub control part for controlling a power supply of the video recording apparatus and for controlling communication with a medium control part disposed in the first recording part so as to control read and write on the first recording medium, the sub control part including
a judgment portion for checking whether or not the set information of the first recording part transmitted from the first transmission portion has been received, and
a second transmission portion for transmitting the set information of the first recording part to the medium control part if the judgment portion judges that the set information of the first recording part has been received.

2. The video recording apparatus according to claim 1,
wherein the sub control part further comprises
a generating portion for generating a communication controlling portion for controlling communication with the medium control part based on the received set information if the judgment portion judges that the set information of the first recording part has been received.

3. The video recording apparatus according to claim 1,
wherein the first transmission portion transmits the set information of the first recording part when the power supply is switched on for the first time.

4. The video recording apparatus according to claim 1, further comprising:
a second recording part having a second recording medium for storing the video information received by the video recording apparatus, operation of the second recording part being controlled by the main control part; and
a third recording part having a third recording medium for storing the video information received by the video recording apparatus, operation of the third recording part being controlled by the main control part.

5. The video recording apparatus according to claim 1,
wherein each of the main control part, the sub control part and the medium control part is made up of a microcomputer.

6. The video recording apparatus according to claim 2,
wherein the first transmission portion transmits the set information of the first recording part when the power supply is switched on for the first time.

7. The video recording apparatus according to claim 2, further comprising:
a second recording part having a second recording medium for storing the video information received by the video recording apparatus, operation of the second recording part being controlled by the main control part; and
a third recording part having a third recording medium for storing the video information received by the video recording apparatus, operation of the third recording part being controlled by the main control part.

8. The video recording apparatus according to claim 3, further comprising:
a second recording part having a second recording medium for storing the video information received by the video recording apparatus, operation of the second recording part being controlled by the main control part; and
a third recording part having a third recording medium for storing the video information received by the video recording apparatus, operation of the third recording part being controlled by the main control part.

9. The video recording apparatus according to claim 4,
wherein the first recording part is a VCR recording part having a VCR (Video Cassette Recorder) as the first recording medium,
the second recording part is an HDD (Hard Disk Drive) having a hard disk as the second recording medium, and
the third recording part is a DVD recording part having a DVD (Digital Versatile Disc) as the third recording medium.

10. The video recording apparatus according to claim 6, further comprising:
a second recording part having a second recording medium for storing the video information received by the video recording apparatus, operation of the second recording part being controlled by the main control part; and
a third recording part having a third recording medium for storing the video information received by the video recording apparatus, operation of the third recording part being controlled by the main control part.

11. The video recording apparatus according to claim 7,
wherein the first recording part is a VCR recording part having a VCR (Video Cassette Recorder) as the first recording medium,
the second recording part is an HDD (Hard Disk Drive) having a hard disk as the second recording medium, and
the third recording part is a DVD recording part having a DVD (Digital Versatile Disc) as the third recording medium.

12. The video recording apparatus according to claim 8,
wherein the first recording part is a VCR recording part having a VCR (Video Cassette Recorder) as the first recording medium,
the second recording part is an HDD (Hard Disk Drive) having a hard disk as the second recording medium, and
the third recording part is a DVD recording part having a DVD (Digital Versatile Disc) as the third recording medium.

13. The video recording apparatus according to claim 10,
wherein the first recording part is a VCR recording part having a VCR (Video Cassette Recorder) as the first recording medium,
the second recording part is an HDD (Hard Disk Drive) having a hard disk as the second recording medium, and
the third recording part is a DVD recording part having a DVD (Digital Versatile Disc) as the third recording medium.
